(19) United States
(12) Patent Application Publication
(10) Pub. No.: US 2026/0080663 A1
(43) Pub. Date: Mar. 19, 2026

(54) SYSTEMS AND METHODS FOR ARTIFICIAL INTELLIGENCE/MACHINE LEARNING ("AI/ML") SMART GATEWAY

(71) Applicant: Verizon Patent and Licensing Inc., Basking Ridge, NJ (US)

(72) Inventors: Hitesh K. Patel, San Diego, CA (US); Rakshit Trivedi, Parsippany, NJ (US); Scott R. Tanner, Sharpsburg, GA (US); Vidhya Seran, Irving, TX (US); Sergey Virodov, San Diego, CA (US); Indraneel Sen, Florham Park, NJ (US); Syed Meeran Kamal, Kendall Park, NJ (US); Chris Halton, Park Ridge, NJ (US); Gaurav Goel, Los Gatos, CA (US); Bindu Balan, Basking Ridge, NJ (US)

(73) Assignee: Verizon Patent and Licensing Inc., Basking Ridge, NJ (US)

(21) Appl. No.: 18/888,732

(22) Filed: Sep. 18, 2024

(51) Int. Cl. G06V 10/764

(52) U.S. Cl. CPC G06V 10/764

(57) ABSTRACT

A system described herein may receive a first set of artificial intelligence/machine learning (“AI/ML”) models; receive first locally captured video information; generate a second set of AI/ML models based on the first set of AI/ML models and the locally captured video information; receive second locally captured video information; identify, based on the second locally captured video information and the second set of AI/ML models, one or more classifications for the second locally captured video information; and output, via a network and to an action system, the one or more classifications, without outputting the second locally captured video information via the network, wherein the action system identifies a particular action associated with the one or more classifications, and performs the identified particular action.

### BACKGROUND

Networks provide connectivity to computing devices such as mobile telephones, tablets, Internet of Things (“IoT”) devices, Machine-to-Machine (“M2M”) devices, laptops, desktop computers, or the like. Networks may provide gateways, modems, or the like, via which wireless network access may be provided at a particular location, premises, household, facility, etc. For example, a family, organization, etc. may connect their devices to a gateway in order to connect to the Internet, communicate with other devices, receive network-based services, or the like.

### BRIEF DESCRIPTION OF THE DRAWINGS

FIG. 1 illustrates an example overview of one or more embodiments described herein;

FIG. 2 illustrates an example of generating a local tuned model, in accordance with some embodiments;

FIG. 3 illustrates an example of performing smart actions based on classifications of locally captured video, in accordance with some embodiments;

FIG. 4 illustrates an example process for classifying locally captured video using locally tuned models and performing smart actions based on the classifications, in accordance with some embodiments;

FIGS. 5 and 6 illustrate example environments in which one or more embodiments, described herein, may be implemented;

FIG. 7 illustrates an example arrangement of a radio access network (“RAN”), in accordance with some embodiments; and

FIG. 8 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

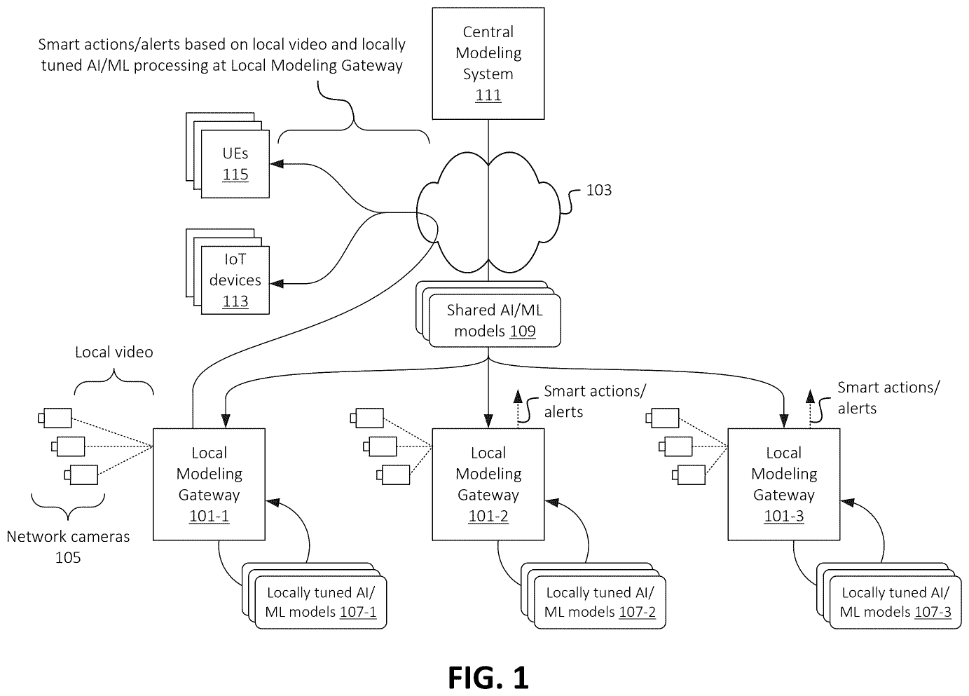

FIG. 1 illustrates an example overview of one or more embodiments. As shown, some embodiments provide one or more Local Modeling Gateways (“LMGs”) 101, which may be deployed at separate locations, such as different households, different facilities, different office buildings, or the like. Similarly, each LMG 101 may be managed or otherwise associated with a different entity, such as a different family, a different organization, or the like. For example, LMG 101-1 may be deployed at a first location and may be associated with a first entity, LMG 101-2 may be deployed at a second location and may be associated with a second entity, LMG 101-3 may be deployed at a third location and may be associated with a third entity, and so on.

LMGs 101 may be communicatively coupled to network 103, which may include the Internet, a wireless network (e.g., a Long-Term Evolution (“LTE”) network, a Fifth Generation (“5G”) network, etc.), and/or one or more other networks. LMGs 101 may provide connectivity between local devices and network 103. For example, a given LMG 101 may include one or more communication interfaces, such as wired and/or wireless interfaces, via which a local device (e.g., a device that can be connected to a wired interface or that is in range of a wireless interface) may connect to LMG 101. Further, LMG 101 may include one or more wired and/or wireless interfaces via which LMG 101 may communicate with network 103 (e.g., may route communications between local devices and network 103). In some embodiments, LMG 101 may include a modem, gateway, a Fixed Wireless Access (“FWA”) device, and/or other type of device that performs encoding, decoding, and/or other processing that facilitates providing network connectivity to local devices.

In accordance with some embodiments, the local devices connected to one or more LMGs 101 may include one or more network cameras 105. For example, a given network camera 105 may include one or more wired or wireless interfaces via which network camera 105 may output (e.g., “stream”) video, captured by network camera 105, to or via a respective LMG 101. As one example, a first family located in a first household may deploy a set of network-enabled security cameras at the first household, which may be connected to a first LMG 101-1; while a second family located in a second household may deploy a second set of network-enabled security cameras, which may be connected to a second LMG 101-2.

In accordance with some embodiments, video captured and/or streamed by a set of network cameras 105 may be provided to an associated LMG 101, but may not be forwarded, routed, etc. to network 103. In this sense, the video captured by a respective set of network cameras 105 and communicated to an associated LMG 101 may be considered as “local” video, as the video is not provided off-premises (e.g., is not provided to another device or system via network 103).

In some embodiments, LMGs 101 may include specialized hardware circuitry to perform automated processing on locally received video (e.g., as captured by a respective set of network cameras 105), such as one or more ai processing units (“APUs”), graphics processing units (“GPUs”), GPU-based processing units, neural processing units (“NPUs”), and/or other suitable hardware circuitry. In some embodiments, the automated processing performed on the local video, by LMGs 101, may include AI/ML processing or other suitable types of processing.

As discussed below, such processing may include generating one or more locally tuned AI/ML models 107, which may be used to perform smart actions, provide alerts, etc. based on local video captured by one or more local network cameras 105. In some embodiments, each LMG 101 may receive (e.g., via network 103) one or more shared AI/ML models 109 from Central Modeling System (“CMS”) 111. CMS 111 may, for example, receive, generate, refine, etc. shared AI/ML models 109 using AI/ML techniques or other suitable techniques. In some embodiments, shared AI/ML models 109 may include one or more large language models (“LLMs”).

Shared AI/ML models 109 may, for example, associate a set of inputs with a set of outputs. Shared AI/ML models 109 may be generated, refined, etc. based on training data or other information associated with multiple sources, which may include publicly available data and/or data provided by multiple distinct entities. Further, shared AI/ML models 109 may be distributed (e.g., by CMS 111) to multiple LMGs 101. Such distribution may be part of, for example, a firmware update, a configuration operation, or the like. In some embodiments, LMGs 101 may implement an application programming interface (“API”), a software development kit (“SDK”), an application, and/or some other suitable communication pathway via which CMS 111 may provide shared AI/ML models 109 to LMGs 101. CMS 111 may thus be considered “central” inasmuch as CMS 111 may distribute some or all of the same shared AI/ML models 109 to multiple devices or systems, including multiple LMGs 101 deployed at multiple separate locations. In some embodiments, CMS 111 may be implemented by a server, a cloud computing system, a virtualized environment, and/or some other suitable set of network-accessible hardware resources.

As discussed below, each LMG 101 may further tune, refine, etc. shared AI/ML models 109 in order to generate respective locally tuned AI/ML models 107. For example, LMG 101-1 may automatically (e.g., without a specific request from a user associated with LMG 101-1, in some embodiments) generate one or more locally tuned AI/ML models 107-1 based on one or more shared AI/ML models 109. In some embodiments, the generation of locally tuned AI/ML model 107 may further be based on locally available information (e.g., information that is not forwarded to network 103), such as based on local video captured by one or more network cameras 105 connected to LMG 101-1. As one example, a given shared AI/ML model 109 may include attributes that are able to be used to identify a dog that is depicted in captured video and/or images. LMG 101-1 may, by way of including hardware that is capable of performing complex processing such as AI/ML processing, further refine such shared AI/ML model 109 to include attributes that can be used to identify a particular dog (e.g., as opposed to a dog in general) that is depicted in local video captured by network cameras 105 that are connected to LMG 101-1. As discussed below, such attributes may be identified by LMG 101-1 based on identifying that features or attributes of local video are applicable to a given shared AI/ML model 109, and LMG 101-1 may further refine or tune such shared AI/ML model 109 (e.g., in order to generate a respective locally tuned AI/ML model 107) to identify specific features of a particular dog, such as a dog that lives inside a home in which network cameras 105 are placed.

The local tuning of shared AI/ML models 109 (e.g., generation and/or refinement of locally tuned AI/ML models 107), in accordance with some embodiments, may provide for more specific and accurate classifications or identifications of people, objects, animals, actions, etc. depicted in captured local video, than using shared AI/ML models 109 themselves, thus improving the user experience. Additionally, as noted above, since locally tuned AI/ML models 107 are local to respective LMGs 101, LMGs 101 may be able to utilize complex AI/ML techniques to classify features of local video, without needing to provide the video itself to AI/ML hardware via network 103 (e.g., to CMS 111, to one or more cloud computing AI/ML systems, etc.), thus enhancing the security and privacy of entities that deploy LMGs 101 (e.g., families that place a given LMG 101 in their home, organizations that deploy one or more LMGs 101 in an office or facility, etc.).

Further, as shown, smart actions, alerts, etc. may be triggered based on people, objects, animals, actions, etc. detected by LMGs 101 in locally captured video. Smart actions may include, for example, outputting control messages to one or more IoT devices 113 or other controllable devices, such as sirens, smart home appliances, cameras, automated guided vehicles (“AGVs”), or the like. As another example, alerts may be sent to a User Equipment (“UE”) 115 such as a mobile telephone or other network-enabled device (e.g., as a text message, as a phone call, as a notification, etc.).

In this sense, some embodiments provide for a complete end-to-end solution that provides for fine-tuned detection of specific objects, individuals, events, etc. depicted in locally captured video, as well as tangible, real-world actions performed in response to such detection. As noted above, this complete solution provides privacy to users associated with LMGs 101, as local video does not ever need to leave a premises at which LMGs 101 are deployed (e.g., LMGs 101 do not need to forward any video information to or via network 103 in order to analyze the video and detect objects, events, etc.).

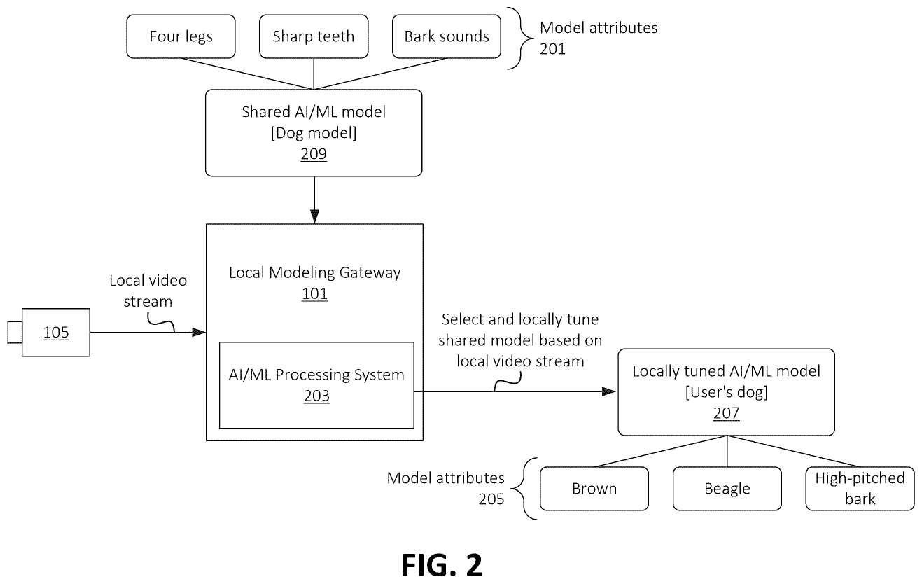

FIG. 2 illustrates one example of LMG 101 generating a particular locally tuned AI/ML model 107 based on a given shared AI/ML model 109 as well as based on locally captured video, as received from one or more network cameras 105 that are communicatively coupled to LMG 101. As shown, LMG 101 may receive a local video stream from one or more network cameras 105. As discussed above, network cameras 105 may be communicatively coupled to LMG 101 via a local network (e.g., a Local Area Network (“LAN”), a wireless LAN (“WLAN”), etc.) that is implemented or provided by LMG 101. For example, network cameras 105 may be connected to LMG 101 via one or more wired connections (e.g., via an Ethernet cable and Registered Jack (“RJ”)-45 ports, a Multimedia over Coax Alliance (“MoCA”) connection, or other suitable types of wired connections) and/or one or more wireless connections (e.g., a Wi-Fi connection, a Bluetooth® connection, or the like).

In some embodiments, LMG 101 and/or network camera 105 may be configured in such a manner that LMG 101 “recognizes” that network camera 105 captures and provides video information (e.g., streaming video) to LMG 101. For example, network camera 105 may be registered with LMG 101 during a discovery, registration, and/or configuration procedure, whereby an Internet Protocol (“IP”) address, device identifier, or other suitable information associated with network camera 105 is provided to LMG 101. As noted above, network camera 105 and LMG 101 may, in some embodiments, implement an API, an SDK, an application, etc. that facilitates the registration of one or more network cameras 105 with LMG 101. In some embodiments, network cameras 105 may be connected to one or more other types of devices, such as a smart hub, a camera gateway, or the like, which are connected to LMG 101 and via which LMG 101 receives local video streams captured by network cameras 105. Although referred to as “video” information, in some embodiments, network cameras 105 may capture and/or provide audio information in addition to, or in lieu of, video information. For example, a given video stream from a particular network camera 105 may include both audio and video information.

In this example, LMG 101 may also receive, among other shared AI/ML models 109, a particular shared AI/ML model 209. In this example, shared AI/ML model 209 may be used to identify dogs that are depicted in video and/or image information. For example, shared AI/ML model 209 may include a set of model attributes 201, such as “four legs,” “sharp teeth,” and “bark sounds.” Shared AI/ML model 209 may, for example, specify how to analyze video information and may include particular features, that may be identified in the video information, that indicate the presence of “four legs,” “sharp teeth,” and “bark sounds.” Such features may include patterns or gradients of pixels, colors, shapes, waveforms, audible information, etc., which may be used (e.g., by LMG 101) to identify the presence of some or all of these attributes 201 in video information received from one or more network cameras 105.

Shared AI/ML model 209 may also indicate an affinity, a relationship, a correlation, weights, etc., between model attributes 201 and a particular output, such as a classification that a given video stream depicts a dog. For example, if a given video stream is analyzed according to shared AI/ML model 209 and is determined to include “four legs,” “sharp teeth,” and “bark sounds,” the given video stream may be determined as depicting a dog. In practice, other scenarios may exist in which the video stream is determined as depicting a dog (e.g., the video stream depicts “four legs” and “sharp teeth” but does not depict “bark sounds,” for example).

As noted above, shared AI/ML model 209 may be a “general” model that may potentially be based on video information from numerous sources. As such, shared AI/ML model 209 may not be tuned to identify features that pertain to a specific user, entity, household etc. As such, it is perceivable that the use of shared AI/ML model 209 may potentially result in false positives (e.g., a dog being erroneously detected in video received from network camera 105) or in false negatives (e.g., a dog depicted in video received from network camera 105 is not detected), due to a lack of specificity in shared AI/ML model 209 with respect to particular features or attributes of a given dog that, for example, resides in a household in which network camera 105 is deployed.

As further shown, and as noted above, LMG 101 may include AI/ML Processing System (“APS”) 203. APS 203 may, in some embodiments, include one or more GPUs, NPUs, or other specialized AI/ML processing hardware, that is capable of using shared AI/ML model 209 to identify features, attributes, objects, etc. depicted in video information received from network camera 105 in real time or near-real time. Further, APS 203 may be capable of refining shared AI/ML model 209 (and/or other shared AI/ML models 109) to generate locally tuned AI/ML model 207 (and/or other locally tuned AI/ML models 107). In some embodiments, AGS 203 may be integrated within LMG 101 (e.g., as a fixed component in an assembly that implements LMG 101). In other embodiments, AGS 203 may be implemented as a detachable unit that may be included in LMG 101 upon a connection event (e.g., cable connection, slot insertion, network connection, or the like).

The use of APS 203 with LMG 101 may simplify the deployment of a powerful gateway that not only provides network access to a premises, but also performs complex computing operations (e.g., AI/ML operations, as discussed herein) without necessitating the off-premises transmission of potentially sensitive or private data, such as locally captured video information. Additionally, providing LMG 101 with APS 203 eliminates the need for configuring a separate AI/ML-based system at a given premises in order to process locally captured video.

APS 203 may, for example, identify that shared AI/ML model 209 is applicable to a given video stream (e.g., may select shared AI/ML model 209 out of a set of candidate shared AI/ML models 109 that are received from CMS 111), based on identifying that features of the video stream match, meet, satisfy, etc. one or more of model attributes 201 of shared AI/ML model 209. Over time, APS 203 may further refine shared AI/ML model 209 to generate locally tuned AI/ML model 207, which may include or inherit some or all model attributes 201 of shared AI/ML model 209, and/or may include further attributes or features. In this example, locally tuned AI/ML model 207 refers to not only a dog in general, but to a particular dog that has been depicted in local video received from network cameras 105 that are communicatively coupled to LMG 101 (e.g., which are deployed at the same premises as LMG 101). For example, the dog based on which locally tuned AI/ML model 207 is generated may be the pet of a user who resides at the premises at which network cameras 105 and LMG 101 are deployed, installed, etc. The particular dog may have further features in addition to features specified in shared AI/ML model 209 (e.g., in addition to model attributes 201). In this example, the dog may have the features “brown,” “beagle,” and “high-pitched bark.” As such, locally tuned AI/ML model 207 may have corresponding model attributes 205, that specify how to detect the features “brown,” “beagle,” and “high-pitched bark” in locally captured video received from network cameras 105, and may further correlate such model attributes 205 with a classification of “user's dog” (e.g., as opposed to the general classification of “dog”). In some embodiments, locally tuned AI/ML model 207 may include some or all of model attributes 201, in addition to model attributes 205.

Identifying model attributes 205 for locally tuned AI/ML model 207 may aid in the identification of the particular dog (based on which locally tuned AI/ML model 207 was generated), as opposed to other dogs. For example, the user may desire for a smart action, alert, etc. to be triggered based on video information depicting the particular dog, but may not desire for such smart action, alert, etc. to be triggered based on video information depicting other dogs. As another example, the user may desire for a smart action, alert, etc. to be triggered based on video information depicting dogs other than the particular dog, such as a scenario in which a neighbor's dog, a stray dog, and/or some other dog not owned by the user enters the user's premises.

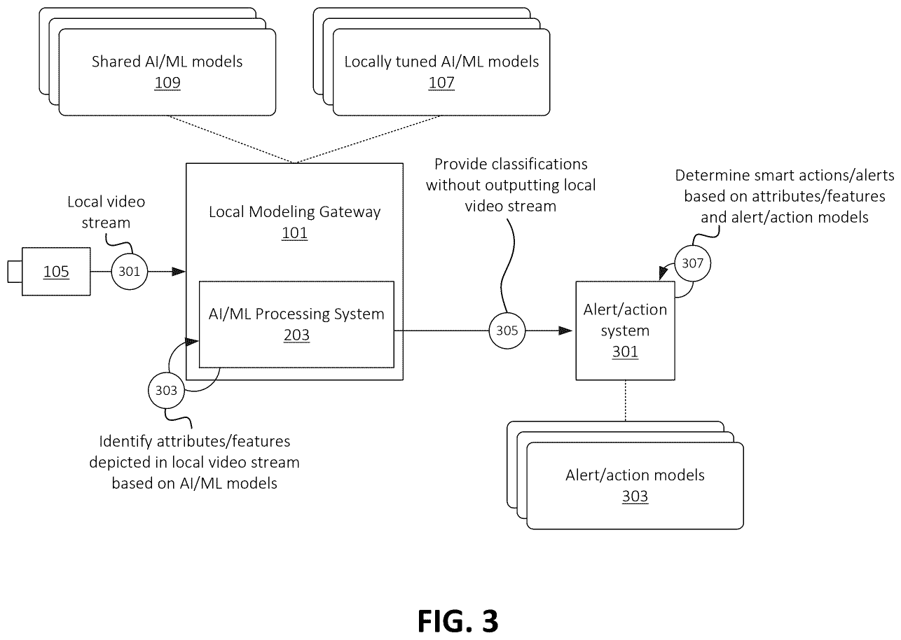

FIG. 3 illustrates an example of utilizing locally tuned AI/ML models 207 to locally (e.g., without sending video information off-premises such as via network 103) identify features such as objects, people, animals, actions, etc. depicted in a local video stream. As shown, LMG 101 may receive (at 301) a local video stream from one or more network cameras 105, such as network cameras 105 that are connected to LMG 101 via a wired or wireless interface (e.g., that connect to a LAN or WLAN implemented by LMG 101). LMG 101 may maintain one or more locally tuned AI/ML models 107 and/or shared AI/ML models 109. For example, as discussed above, APS 203 may generate locally tuned AI/ML models 107 (e.g., including locally tuned AI/ML model 207 and/or other locally generated or refined models) based on video information received over time. As also noted above, locally tuned AI/ML models 107 may be generated (e.g., by APS 203) based on modifying or refining one or more shared AI/ML models 109.

LMG 101 (e.g., APS 203) may identify (at 303) attributes and/or features depicted in the local video stream based on locally tuned AI/ML models 107 and/or shared AI/ML models 109. Continuing with the above example, for instance, LMG 101 may identify the presence of a particular dog (e.g., as indicated based on attributes of a particular locally tuned AI/ML model 107), such as a dog who is a pet of a user who has deployed and/or installed LMG 101 and network cameras 105 at the user's home. For example, LMG 101 may classify a particular video stream, or a portion thereof (e.g., one or more images, frames, segments, etc.) as depicting the particular dog, based on identifying that the video stream depicts features specified in a particular locally tuned AI/ML model 107 (e.g., locally tuned AI/ML model 207).

LMG 101 may, in some embodiments, output (at 305) classification and/or attribute information associated with the video stream, without outputting the video stream itself, to alert/action system 301. Alert/action system 301 may, for example, be a cloud-based or network-accessible resource (e.g., a web server, a cloud computing system, etc. that is accessible via network 103). Alert/action system 301 may maintain a set of alert/action models 303, which may specify actions to take in response to a given classification (e.g., where the classification relates to objects, animals, people, actions, etc. indicated by respective LMGs 101 based on analyzing locally captured video).

Alert/action models 303 may, for example, be generated or refined using AI/ML techniques, in order to identify optimal or desired actions to take in response to particular classifications identified with respect to locally captured video streams. In some embodiments, alert/action models 303 may include or may be generated based on user preferences or user-specified actions. For example, a user of LMG 101 may, using a graphical user interface (“GUI”) implemented by alert/action system 301, specify actions such as providing alerts (e.g., to a device associated with the user, such as the user's smart phone or a smart appliance located within the user's home), activating an audible alarm (e.g., a siren or other audio output device), triggering a recording mode by a particular network camera 105 (e.g., where such network camera 105 may not be in a recording mode in the absence of such a triggering command), and/or other actions. As noted above, the actions may include providing instructions, commands, etc. to an IoT device or other suitable type of device that is capable of receiving and implementing such instructions, commands, etc.

In some embodiments, different sets of alert/action models 303 may be associated with different particular LMGs 101. For example, a first LMG 101 (e.g., associated with a first user) may be associated with a first set of alert/action models 303, while a second LMG 101 (e.g., associated with a second user) may be associated with a second set of alert/action models 303. The different sets of alert/action models 303 may be generated, refined, etc. based on being associated with different users or entities. For example, alert/action system 301 may identify attributes of each user (e.g., a location of each user, a user profile of each user, etc.), and may automatically generate or refine the respective sets of alert/action models 303 based on such attributes. Additionally, or alternatively, alert/action system 301 may receive different preferences or selections from the different users, based on which alert/action system 301 may generate, refine, maintain, etc. the different sets of alert/action models 303. In this manner, alert/action system 301 may be able to identify diverse sets of actions to perform in response to classifications received from LMGs 101, depending on which LMG 101 provides a given set of classifications.

Alert/action system 301 may, for example, based on receiving (at 305) a particular classification from a particular LMG 101, identify (at 307) a particular alert/action model 303 that is associated with the particular classification. Alert/action system 301 may further identify one or more actions to perform, as indicated by the particular alert/action model 303. In the example of a particular dog being indicated in the classification provided (at 305), a particular alert/action model 303 may indicate that a particular audio output device (e.g., an IoT device that includes a siren or other type of audible alarm, such as an IoT device that is deployed at the same premises as LMG 101) should be instructed to make an audible alarm. As another example, the particular alert/action model 303 may indicate that a text message should be sent to a particular smart phone (e.g., to a Mobile Directory Number (“MDN”) associated with the user of LMG 101).

In some embodiments, the classification information (provided at 305) may include other information, such as a location of a particular network camera 105 from which a video stream is received. For example, multiple network cameras 105 may be deployed at a given premises, where each network camera 105 is associated with an identifier or indicator. The identifiers or indicators may be used, for example, to differentiate between cameras that are located at different locations within a given premises, such as a first network camera 105 that is associated with a backyard of the premises, a second network camera 105 that is associated with a dining room of the premises, and so on.

Additionally, in some embodiments, alert/action models 303 may further be associated with different particular network cameras 105. For example, a given alert/action model 303 may specify that if the particular dog is depicted in video information received from the particular network camera 105 that is located in the backyard, that a text message should be sent to a user of LMG 101. On the other hand, alert/action model 303 may not specify that the text message should be sent to the user if the particular dog is depicted in video information received from another network camera 105, such as a particular network camera 105 that is located in the dining room. Alert/action model 303 may, for example, be useful for situations in which the particular dog is not permitted to be located outdoors, and may alert the user that the dog has potentially escaped from the inside of the home.

While examples of some embodiments are discussed above in the context of a particular dog, similar concepts are applicable to any suitable type of identifiable feature depicted in video information (e.g., as captured by one or more network cameras 105 and locally provided to one or more respective LMGs 101). As another example, a particular set of locally tuned AI/ML models 107, maintained by a given LMG 101, may include attributes or features depicting individuals who have been identified, over time, in locally received video information captured by local network cameras 105. Such locally tuned AI/ML models 107 may each be associated with, for example, members of a family who reside at a home in which network cameras 105 and LMG 101 are deployed. Locally tuned AI/ML models 107 may, for example, have been generated based on refining one or more shared AI/ML models 109 that include general features or attributes of people, but are not specifically directed to the particular members of the family.

Assume that a particular network camera 105 may include a “doorbell camera” that is situated such that a front porch, stoop, patio, etc. of a home are depicted in video information captured by the particular network camera 105. In one example situation, video information captured by the particular network camera 105 may depict a group of packages that have been placed on the front porch. In accordance with some embodiments, the user of LMG 101 may be alerted (e.g., via a text message, an in-app notification, etc.) that the packages have been placed on the front porch (e.g., in accordance with one or more alert/action models 303).

Further assume that, at some point in time after the packages have been placed on the front porch, video information captured by network camera 105 depicts a person removing the packages. In a situation where the person depicted in the video information is not specified by one or more locally tuned AI/ML models 107, the user of LMG 101 may be alerted, a siren that is proximate to the front porch may be automatically activated, or the like. Because the person depicted in the video information is not specified by locally tuned AI/ML models 107, one or more alert/action models 303 may specify that the user of LMG 101 should be alerted, that the siren should be activated, etc. For example, since the person depicted in the video information is not specified by locally tuned AI/ML models 107, it may be likely that this person is not a resident or familiar person with respect to the house, and may be stealing the packages. On the other hand, in a situation where the packages are collected by a person who is specified in one or more locally tuned AI/ML models 107, no actions may be performed (or a different set of actions may be performed, such as outputting a notification to one or more users of LMG 101, without activating a siren).

As another example, LMG 101 may utilize locally tuned AI/ML models 107 to track particular objects, such as a user's glasses, car keys, etc. For example, video information provided by network cameras 105 may depict such objects, and LMG 101 may generate or refine locally tuned AI/ML models 107 that specify features or attributes of such objects. When receiving video information from network cameras 105, LMG 101 may utilize locally tuned AI/ML models 107 to identify that particular objects have been identified. LMG 101 may further utilize information associated with respective network cameras 105 (e.g., location or position information, such as which room a given network camera 105 is located in), to identify where the objects have been identified. In this manner, LMG 101 may maintain location information for specific objects (e.g., where such location information is determined based on identifying objects depicted in locally captured video).

A given user may request, from LMG 101, the location information for a given object. For example, the user may use voice commands to communicate with an application running on the user's smartphone or a smart home device, such as “Where are my glasses?” Such application may implement an API, SDK, etc. whereby the application provides the request to LMG 101. LMG 101 may identify that “my glasses” refers to particular glasses associated with one or more locally tuned AI/ML models 107, and further that LMG 101 has previously identified the presence of the particular glasses at a particular location (e.g., based on analyzing locally captured video information and comparing such information to the locally tuned AI/ML model 107 that includes attributes of the particular glasses). LMG 101 may reply with the location of the glasses, which may include indicating a room in which a particular network camera 105 is located (e.g., where the particular network camera 105 has provided locally captured video that depicts the glasses).

As another example, a given locally tuned AI/ML model 107 may include features or attributes of a particular individual, such as a child that resides in a home in which LMG 101 is deployed. In one example situation, LMG 101 may receive locally captured video that depicts the child exiting a front door of the home. LMG 101 may generate or output classification information (e.g., to alert/action system 301), indicating that locally captured video information depicts the child exiting the front door. In accordance with one or more alert/action models 303, alert/action system 301 may perform one or more actions, such as providing a notification to a smartphone of a user associated with LMG 101 (e.g., the child's parent), activating an audible alert at a smart home device (e.g., “go back inside,” which may be heard by the child), and/or other suitable actions.

In another example, LMG 101 may identify a fire depicted in locally captured video. In some embodiments, LMG 101 may further maintain one or more locally tuned AI/ML models 107 that indicate particular rooms or spaces within a home, such as a kitchen, a bedroom, etc. LMG 101 may provide (e.g., to alert/action system 301) an indication that a fire has been detected (e.g., based on locally captured video), as well as an indication of a particular room in which the fire has been detected. One or more alert/action models 303 may include actions such as outputting an alert (e.g., to a smartphone of a user associated with LMG 101), indicating that a fire has been detected, and further indicating where the fire has been detected (e.g., in which particular room). As another example, a given alert/action model 303 may indicate that a smart appliance, such as a smart stove, located in a room in which a fire has been detected should be powered off.

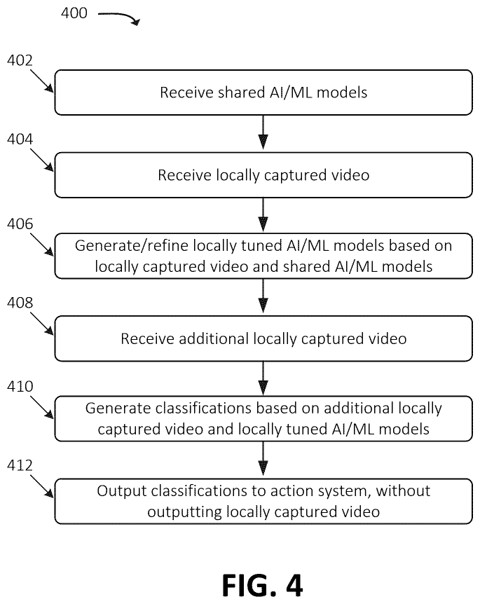

FIG. 4 illustrates an example process 400 for classifying locally captured video using locally tuned models and performing smart actions based on the classifications. In some embodiments, some or all of process 400 may be performed by LMG 101. In some embodiments, one or more other devices may perform some or all of process 400 in concert with and/or in lieu of LMG 101, such as alert/action system 301.

As shown, process 400 may include receiving (at 402) a first set of AI/ML models, such as a shared set of AI/ML models. For example, as discussed above, a particular LMG 101 may receive shared AI/ML models 109 from CMS 111, which may have been generated or refined based on diverse and varied data sources (e.g., thousands or millions of separate data sources). As discussed above, shared AI/ML models 109 may not have been refined or tuned on the basis of any one individual user or entity, such as a user or entity associated with the particular LMG 101.

Process 400 may further include receiving (at 404) locally captured video. For example, as discussed above, LMG 101 may be communicatively coupled to (e.g., via a LAN, a WLAN, etc.) to one or more network cameras 105, which may provide one or more video streams (e.g., on an ongoing basis, an event-driven basis, and/or some other suitable basis) to LMG 101. The video may be “local” inasmuch as LMG 101 does not receive the video information via an external network, such as the Internet. For example, LMG 101 may receive the video information via a network implemented by LMG 101 itself, such as via a LAN or WLAN implemented by network circuitry of LMG 101 (e.g., via one or more Ethernet or RJ45 jacks, via one or more Wi-Fi or Bluetooth® radios, etc.).

As discussed above, the network circuitry used by LMG 101 to implement the LAN, WLAN, etc. may be separate from network circuitry used by LMG 101 to communicate with the external network. For example, LMG 101 may include a modem, fiber optic port, FWA device, etc. via which LMG 101 communicates with the external network, where such network circuitry is separate and distinct from network circuitry used to implement the LAN or WLAN via which LMG 101 receives locally captured video information.

Process 400 may additionally include generating and/or refining (at 406) one or more locally tuned AI/ML models 107 based on the locally captured video information and the received shared AI/ML models 109. For example, LMG 101 may utilize AI/ML processing hardware (e.g., APS 203) to perform AI/ML techniques to identify one or more objects, animals, people, actions, etc. depicted in the locally captured video information (e.g., may identify features, attributes, etc. of locally captured video information that meets, matches, etc. parameters of one or more shared AI/ML models 109). LMG 101 (e.g., APS 203) may identify additional features, attributes, etc. of detected objects, animals, people, etc. in order to generate one or more locally tuned AI/ML models 107. As discussed above, locally tuned AI/ML models 107 may be more specifically directed to particular objects, animals, people, etc. than shared AI/ML models 109.

Process 400 may also include receiving (at 408) additional locally captured video. For example, after locally tuned AI/ML models 107 have been generated, LMG 101 may receive further locally captured video from one or more communicatively coupled network cameras 105.

Process 400 may further include generating (at 410) classifications based on the additional locally captured video, and further based on one or more locally tuned AI/ML models 107. For example, LMG 101 (e.g., APS 203) may identify that the additional locally captured video depicts particular objects, animals, people, etc. specified by the one or more locally tuned AI/ML models 107. As noted above, LMG 101 may make such classifications without outputting the video itself off-premises (e.g., without outputting the video information to an external device or system via network 103).

Process 400 may additionally include outputting (at 412) the classifications to an action system (e.g., to alert/action system 301). Outputting the classifications to alert/action system 301 may facilitate the performing of smart actions, which may have been configured or requested by a user of LMG 101, and/or which may have been automatically generated or refined (e.g., using AI/ML techniques). In this manner, flexible and dynamic actions may be specified for particular features depicted in local streaming video (e.g., where such features are locally tuned on a per-user or per-LMG 101 basis), without needing to provide the local video to an external device or system, thus preserving privacy of the user as well as reducing consumption of network bandwidth that would otherwise be consumed by outputting the video information via network 103.

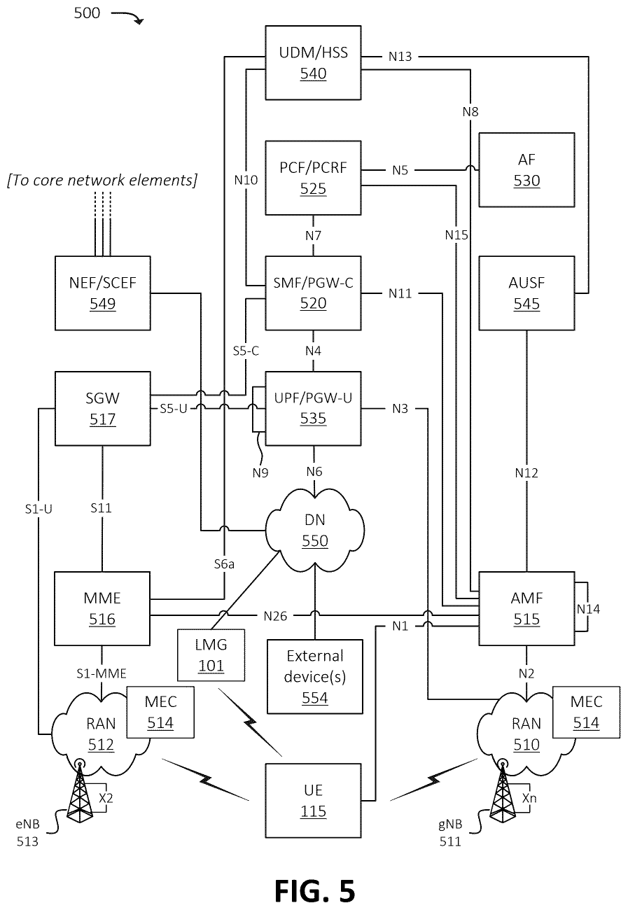

FIG. 5 illustrates an example environment 500, in which one or more embodiments may be implemented. In some embodiments, environment 500 may correspond to a Fifth Generation (“5G”) network, and/or may include elements of a 5G network. In some embodiments, environment 500 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 500 may represent or may include a 5G core (“5GC”). As shown, environment 500 may include UE 115, RAN 510 (which may include one or more Next Generation Node Bs (“gNBs”) 511), RAN 512 (which may include one or more evolved Node Bs (“eNBs”) 513), and various network functions such as Access and Mobility Management Function (“AMF”) 515, Mobility Management Entity (“MME”) 516, Serving Gateway (“SGW”) 517, Session Management Function (“SMF”)/Packet Data Network (“PDN”) Gateway (“PGW”)-Control plane function (“PGW-C”) 520, Policy Control Function (“PCF”)/Policy Charging and Rules Function (“PCRF”) 525, Application Function (“AF”) 530, User Plane Function (“UPF”)/PGW-User plane function (“PGW-U”) 535, Unified Data Management (“UDM”)/Home Subscriber Server (“HSS”) 540, Authentication Server Function (“AUSF”) 545, and Network Exposure Function (“NEF”)/Service Capability Exposure Function (“SCEF”) 549. Environment 500 may also include one or more networks, such as Data Network (“DN”) 550. Environment 500 may include one or more additional devices or systems communicatively coupled to one or more networks (e.g., DN 550), such as one or more external devices 554.

The example shown in FIG. 5 illustrates one instance of each network component or function (e.g., one instance of SMF/PGW-C 520, PCF/PCRF 525, UPF/PGW-U 535, UDM/HSS 540, and/or AUSF 545). In practice, environment 500 may include multiple instances of such components or functions. For example, in some embodiments, environment 500 may include multiple “slices” of a core network, where each slice includes a discrete and/or logical set of network functions (e.g., one slice may include a first instance of AMF 515, SMF/PGW-C 520, PCF/PCRF 525, and/or UPF/PGW-U 535, while another slice may include a second instance of AMF 515, SMF/PGW-C 520, PCF/PCRF 525, and/or UPF/PGW-U 535). The different slices may provide differentiated levels of service, such as service in accordance with different Quality of Service (“QoS”) parameters.

The quantity of devices and/or networks, illustrated in FIG. 5, is provided for explanatory purposes only. In practice, environment 500 may include additional devices and/or networks, fewer devices and/or networks, different devices and/or networks, or differently arranged devices and/or networks than illustrated in FIG. 5. For example, while not shown, environment 500 may include devices that facilitate or enable communication between various components shown in environment 500, such as routers, modems, gateways, switches, hubs, etc. In some implementations, one or more devices of environment 500 may be physically integrated in, and/or may be physically attached to, one or more other devices of environment 500. Alternatively, or additionally, one or more of the devices of environment 500 may perform one or more network functions described as being performed by another one or more of the devices of environment 500.

Additionally, one or more elements of environment 500 may be implemented in a virtualized and/or containerized manner. For example, one or more of the elements of environment 500 may be implemented by one or more Virtualized Network Functions (“VNFs”), Cloud-Native Network Functions (“CNFs”), etc. In such embodiments, environment 500 may include, may implement, and/or may be communicatively coupled to an orchestration platform that provisions hardware resources, installs containers or applications, performs load balancing, and/or otherwise manages the deployment of such elements of environment 500. In some embodiments, such orchestration and/or management of such elements of environment 500 may be performed by, or in conjunction with, the open-source Kubernetes® API or some other suitable virtualization, containerization, and/or orchestration system.

Elements of environment 500 may interconnect with each other and/or other devices via wired connections, wireless connections, or a combination of wired and wireless connections. Examples of interfaces or communication pathways between the elements of environment 500, as shown in FIG. 5, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 5, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 500 may be, may include, may be implemented by, and/or may be communicatively coupled to network 103.

UE 115 may include a computation and communication device, such as a wireless mobile communication device that is capable of communicating with RAN 510, RAN 512, and/or DN 550. UE 115 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 115 may send traffic to and/or receive traffic (e.g., user plane traffic) from DN 550 via RAN 510, RAN 512, and/or UPF/PGW-U 535. In some embodiments, UE 115 may receive wired or wireless connectivity via LMG 101, as discussed above.

RAN 510 may be, or may include, a 5G RAN that implements a 5G RAT and that includes one or more base stations (e.g., one or more gNBs 511), via which UE 115 may communicate with one or more other elements of environment 500. UE 115 may communicate with RAN 510 via an air interface (e.g., as provided by gNB 511). For instance, RAN 510 may receive traffic (e.g., user plane traffic such as voice call traffic, data traffic, messaging traffic, etc.) from UE 115 via the air interface, and may communicate the traffic to UPF/PGW-U 535 and/or one or more other devices or networks. Further, RAN 510 may receive signaling traffic, control plane traffic, etc. from UE 115 via the air interface, and may communicate such signaling traffic, control plane traffic, etc. to AMF 515 and/or one or more other devices or networks. Additionally, RAN 510 may receive traffic intended for UE 115 (e.g., from UPF/PGW-U 535, AMF 515, and/or one or more other devices or networks) and may communicate the traffic to UE 115 via the air interface.

RAN 512 may be, or may include, an LTE RAN that implements an LTE RAT and that includes one or more base stations (e.g., one or more eNBs 513), via which UE 115 may communicate with one or more other elements of environment 500. UE 115 may communicate with RAN 512 via an air interface (e.g., as provided by eNB 513). For instance, RAN 512 may receive traffic (e.g., user plane traffic such as voice call traffic, data traffic, messaging traffic, signaling traffic, etc.) from UE 115 via the air interface, and may communicate the traffic to UPF/PGW-U 535 (e.g., via SGW 517) and/or one or more other devices or networks. Further, RAN 512 may receive signaling traffic, control plane traffic, etc. from UE 115 via the air interface, and may communicate such signaling traffic, control plane traffic, etc. to MME 516 and/or one or more other devices or networks. Additionally, RAN 512 may receive traffic intended for UE 115 (e.g., from UPF/PGW-U 535, MME 516, SGW 517, and/or one or more other devices or networks) and may communicate the traffic to UE 115 via the air interface.

One or more RANs of environment 500 (e.g., RAN 510 and/or RAN 512) may include, may implement, and/or may otherwise be communicatively coupled to one or more edge computing devices, such as one or more Multi-Access/Mobile Edge Computing (“MEC”) devices (referred to sometimes herein simply as a “MECs”) 514. MECs 514 may be co-located with wireless network infrastructure equipment of RANs 510 and/or 512 (e.g., one or more gNBs 511 and/or one or more eNBs 513, respectively). Additionally, or alternatively, MECs 514 may otherwise be associated with geographical regions (e.g., coverage areas) of wireless network infrastructure equipment of RANs 510 and/or 512. In some embodiments, one or more MECs 514 may be implemented by the same set of hardware resources, the same set of devices, etc. that implement wireless network infrastructure equipment of RANs 510 and/or 512. In some embodiments, one or more MECs 514 may be implemented by different hardware resources, a different set of devices, etc. from hardware resources or devices that implement wireless network infrastructure equipment of RANs 510 and/or 512. In some embodiments, MECs 514 may be communicatively coupled to wireless network infrastructure equipment of RANs 510 and/or 512 (e.g., via a high-speed and/or low-latency link such as a physical wired interface, a high-speed and/or low-latency wireless interface, or some other suitable communication pathway).

MECs 514 may include hardware resources (e.g., configurable or provisionable hardware resources) that may be configured to provide services and/or otherwise process traffic to and/or from UE 115, via RAN 510 and/or 512. For example, RAN 510 and/or 512 may route some traffic from UE 115 (e.g., traffic associated with one or more particular services, applications, application types, etc.) to a respective MEC 514 instead of to core network elements of 500 (e.g., UPF/PGW-U 535). MEC 514 may accordingly provide services to UE 115 by processing such traffic, performing one or more computations based on the received traffic, and providing traffic to UE 115 via RAN 510 and/or 512. MEC 514 may include, and/or may implement, some or all of the functionality described above with respect to UPF/PGW-U 535, AF 530, one or more application servers, and/or one or more other devices, systems, VNFs, CNFs, etc. In this manner, ultra-low latency services may be provided to UE 115, as traffic does not need to traverse links (e.g., backhaul links) between RAN 510 and/or 512 and the core network.

AMF 515 may include one or more devices, systems, VNFs, CNFs, etc., that perform operations to register UE 115 with the 5G network, to establish bearer channels associated with a session with UE 115, to hand off UE 115 from the 5G network to another network, to hand off UE 115 from the other network to the 5G network, manage mobility of UE 115 between RANs 510 and/or gNBs 511, and/or to perform other operations. In some embodiments, the 5G network may include multiple AMFs 515, which communicate with each other via the N14 interface (denoted in FIG. 5 by the line marked “N14” originating and terminating at AMF 515).

MME 516 may include one or more devices, systems, VNFs, CNFs, etc., that perform operations to register UE 115 with the EPC, to establish bearer channels associated with a session with UE 115, to hand off UE 115 from the EPC to another network, to hand off UE 115 from another network to the EPC, manage mobility of UE 115 between RANs 512 and/or eNBs 513, and/or to perform other operations.

SGW 517 may include one or more devices, systems, VNFs, CNFs, etc., that aggregate traffic received from one or more eNBs 513 and send the aggregated traffic to an external network or device via UPF/PGW-U 535. Additionally, SGW 517 may aggregate traffic received from one or more UPF/PGW-Us 535 and may send the aggregated traffic to one or more eNBs 513. SGW 517 may operate as an anchor for the user plane during inter-eNB handovers and as an anchor for mobility between different telecommunication networks or RANs (e.g., RANs 510 and 512).

SMF/PGW-C 520 may include one or more devices, systems, VNFs, CNFs, etc., that gather, process, store, and/or provide information in a manner described herein. SMF/PGW-C 520 may, for example, facilitate the establishment of communication sessions on behalf of UE 115. In some embodiments, the establishment of communications sessions may be performed in accordance with one or more policies provided by PCF/PCRF 525.

PCF/PCRF 525 may include one or more devices, systems, VNFs, CNFs, etc., that aggregate information to and from the 5G network and/or other sources. PCF/PCRF 525 may receive information regarding policies and/or subscriptions from one or more sources, such as subscriber databases and/or from one or more users (such as, for example, an administrator associated with PCF/PCRF 525).

AF 530 may include one or more devices, systems, VNFs, CNFs, etc., that receive, store, and/or provide information that may be used in determining parameters (e.g., quality of service parameters, charging parameters, or the like) for certain applications.

UPF/PGW-U 535 may include one or more devices, systems, VNFs, CNFs, etc., that receive, store, and/or provide data (e.g., user plane data). For example, UPF/PGW-U 535 may receive user plane data (e.g., voice call traffic, data traffic, etc.), destined for UE 115, from DN 550, and may forward the user plane data toward UE 115 (e.g., via RAN 510, SMF/PGW-C 520, and/or one or more other devices). In some embodiments, multiple instances of UPF/PGW-U 535 may be deployed (e.g., in different geographical locations), and the delivery of content to UE 115 may be coordinated via the N9 interface (e.g., as denoted in FIG. 5 by the line marked “N9” originating and terminating at UPF/PGW-U 535). Similarly, UPF/PGW-U 535 may receive traffic from UE 115 (e.g., via RAN 510, RAN 512, SMF/PGW-C 520, and/or one or more other devices), and may forward the traffic toward DN 550. In some embodiments, UPF/PGW-U 535 may communicate (e.g., via the N4 interface) with SMF/PGW-C 520, regarding user plane data processed by UPF/PGW-U 535.

UDM/HSS 540 and AUSF 545 may include one or more devices, systems, VNFs, CNFs, etc., that manage, update, and/or store, in one or more memory devices associated with AUSF 545 and/or UDM/HSS 540, profile information associated with a subscriber. In some embodiments, UDM/HSS 540 may include, may implement, may be communicatively coupled to, and/or may otherwise be associated with some other type of repository or database, such as a Unified Data Repository (“UDR”). AUSF 545 and/or UDM/HSS 540 may perform authentication, authorization, and/or accounting operations associated with one or more UEs 115 and/or one or more communication sessions associated with one or more UEs 115.

DN 550 may include one or more wired and/or wireless networks. For example, DN 550 may include an Internet Protocol (“IP”)-based PDN, a wide area network (“WAN”) such as the Internet, a private enterprise network, and/or one or more other networks. UE 115 may communicate, through DN 550, with data servers, other UEs 115, and/or to other servers or applications that are coupled to DN 550. DN 550 may be connected to one or more other networks, such as a public switched telephone network (“PSTN”), a public land mobile network (“PLMN”), and/or another network. DN 550 may be connected to one or more devices, such as content providers, applications, web servers, and/or other devices, with which UE 115 may communicate.

External devices 554 may include one or more devices or systems that communicate with UE 115 via DN 550 and one or more elements of 500 (e.g., via UPF/PGW-U 535). In some embodiments, external devices 554 may include, may implement, and/or may otherwise be associated with CMS 111 and/or alert/action system 301. External devices 554 may include, for example, one or more application servers, content provider systems, web servers, or the like. External devices 554 may, for example, implement “server-side” applications that communicate with “client-side” applications executed by UE 115. External devices 554 may provide services to UE 115 such as gaming services, videoconferencing services, messaging services, email services, web services, and/or other types of services.

In some embodiments, external devices 554 may communicate with one or more elements of environment 500 (e.g., core network elements) via NEF/SCEF 549. NEF/SCEF 549 include one or more devices, systems, VNFs, CNFs, etc. that provide access to information, APIs, and/or other operations or mechanisms of one or more core network elements to devices or systems that are external to the core network (e.g., to external device 554 via DN 550). NEF/SCEF 549 may maintain authorization and/or authentication information associated with such external devices or systems, such that NEF/SCEF 549 is able to provide information, that is authorized to be provided, to the external devices or systems. For example, a given external device 554 may request particular information associated with one or more core network elements. NEF/SCEF 549 may authenticate the request and/or otherwise verify that external device 554 is authorized to receive the information, and may request, obtain, or otherwise receive the information from the one or more core network elements. In some embodiments, NEF/SCEF 549 may include, may implement, may be implemented by, may be communicatively coupled to, and/or may otherwise be associated with a Security Edge Protection Proxy (“SEPP”), which may perform some or all of the functions discussed above. External device 554 may, in some situations, subscribe to particular types of requested information provided by the one or more core network elements, and the one or more core network elements may provide (e.g., “push”) the requested information to NEF/SCEF 549 (e.g., in a periodic or otherwise ongoing basis).

In some embodiments, external devices 554 may communicate with one or more elements of RAN 510 and/or 512 via an API or other suitable interface. For example, a given external device 554 may provide instructions, requests, etc. to RAN 510 and/or 512 to provide one or more services via one or more respective MECs 514. In some embodiments, such instructions, requests, etc. may include QoS parameters, Service Level Agreements (“SLAs”), etc. (e.g., maximum latency thresholds, minimum throughput thresholds, etc.) associated with the services.

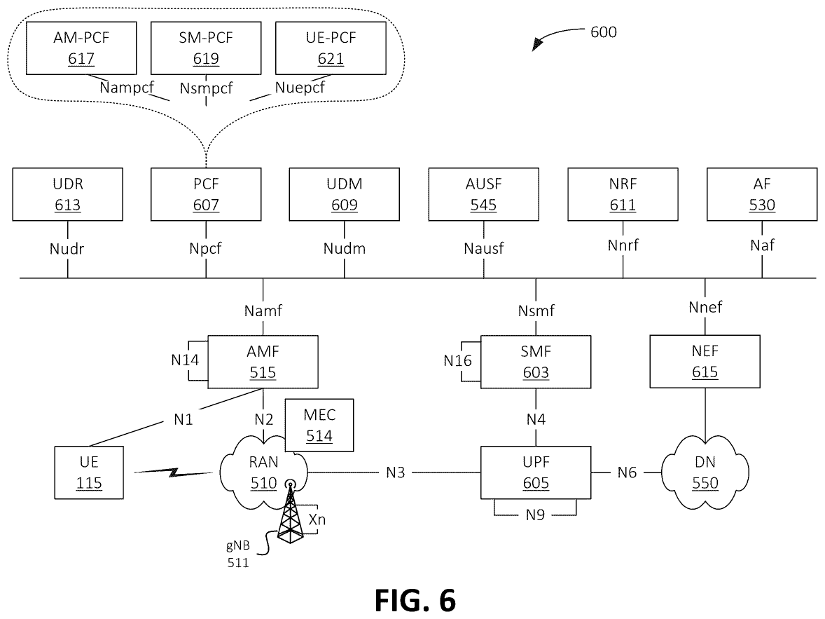

FIG. 6 illustrates another example environment 600, in which one or more embodiments may be implemented. In some embodiments, environment 600 may correspond to a 5G network (e.g., a 5G standalone (“SA”) network), and/or may include elements of a 5G network. In some embodiments, environment 600 may correspond to a 5G SA architecture. In some embodiments, environment 600 may include a 5GC, in which 5GC network elements perform one or more operations described herein.

As shown, environment 600 may include UE 115, RAN 510 (which may include one or more gNBs 511 or other types of wireless network infrastructure) and various network functions, which may be implemented as VNFs, CNFs, etc. Such network functions may include AMF 515, SMF 603, UPF 605, PCF 607, UDM 609, AUSF 545, Network Repository Function (“NRF”) 611, AF 530, UDR 613, and NEF 615. Environment 600 may also include or may be communicatively coupled to one or more networks, such as DN 550.

The example shown in FIG. 6 illustrates one instance of each network component or function (e.g., one instance of SMF 603, UPF 605, PCF 607, UDM 609, AUSF 545, etc.). In practice, environment 600 may include multiple instances of such components or functions. For example, in some embodiments, environment 600 may include multiple “slices” of a core network, where each slice includes a discrete and/or logical set of network functions (e.g., one slice may include a first instance of SMF 603, PCF 607, UPF 605, etc., while another slice may include a second instance of SMF 603, PCF 607, UPF 605, etc.). Additionally, or alternatively, one or more of the network functions of environment 600 may implement multiple network slices. The different slices may provide differentiated levels of service, such as service in accordance with different QoS parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600.

Elements of environment 600 may interconnect with each other and/or other devices via wired connections, wireless connections, or a combination of wired and wireless connections. Examples of interfaces or communication pathways between the elements of environment 600, as shown in FIG. 6, may include interfaces shown in FIG. 6 and/or one or more interfaces not explicitly shown in FIG. 6. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 600 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 515), an Nudm interface (e.g., indicating communications to be routed to UDM 609), an Npcf interface, an Nupf interface, an Nnef interface, an Nsmf interface, an Nnrf interface, an Nudr interface, an Naf interface, and/or one or more other SBIs. In some embodiments, environment 600 may be, may include, may be implemented by, and/or may be communicatively coupled to network 103.

UPF 605 may include one or more devices, systems, VNFs, CNFs, etc., that receive, route, process, and/or forward traffic (e.g., user plane traffic). As discussed above, UPF 605 may communicate with UE 115 via one or more communication sessions, such as PDU sessions. Such PDU sessions may be associated with a particular network slice or other suitable QoS parameters, as noted above. UPF 605 may receive downlink user plane traffic (e.g., voice call traffic, data traffic, etc. destined for UE 115) from DN 550, and may forward the downlink user plane traffic toward UE 115 (e.g., via RAN 510). In some embodiments, multiple UPFs 605 may be deployed (e.g., in different geographical locations), and the delivery of content to UE 115 may be coordinated via the N9 interface. Similarly, UPF 605 may receive uplink traffic from UE 115 (e.g., via RAN 510), and may forward the traffic toward DN 550. In some embodiments, UPF 605 may implement, may be implemented by, may be communicatively coupled to, and/or may otherwise be associated with UPF/PGW-U 535. In some embodiments, UPF 605 may communicate (e.g., via the N4 interface) with SMF 603, regarding user plane data processed by UPF 605 (e.g., to provide analytics or reporting information, to receive policy and/or authorization information, etc.).

PCF 607 may include one or more devices, systems, VNFs, CNFs, etc., that aggregate, derive, generate, etc. policy information associated with the 5GC and/or UEs 115 that communicate via the 5GC and/or RAN 510. PCF 607 may receive information regarding policies and/or subscriptions from one or more sources, such as subscriber databases (e.g., UDM 609, UDR 613, etc.), and/or from one or more users such as, for example, an administrator associated with PCF 607. In some embodiments, the functionality of PCF 607 may be split into multiple network functions or subsystems, such as access and mobility PCF (“AM-PCF”) 617, session management PCF (“SM-PCF”) 619, UE PCF (“UE-PCF”) 621, and so on. Such different “split” PCFs may be associated with respective SBIs (e.g., AM-PCF 617 may be associated with an Nampcf SBI, SM-PCF 619 may be associated with an Nsmpcf SBI, UE-PCF 621 may be associated with an Nuepcf SBI, and so on) via which other network functions may communicate with the split PCFs. The split PCFs may maintain information regarding policies associated with different devices, systems, and/or network functions.

NRF 611 may include one or more devices, systems, VNFs, CNFs, etc. that maintain routing and/or network topology information associated with the 5GC. For example, NRF 611 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 613 may include one or more devices, systems, VNFs, CNFs, etc. that provide user and/or subscriber information, based on which PCF 607 and/or other elements of environment 600 may determine access policies, QoS policies, charging policies, or the like. In some embodiments, UDR 613 may receive such information from UDM 609 and/or one or more other sources.

NEF 615 include one or more devices, systems, VNFs, CNFs, etc. that provide access to information, APIs, and/or other operations or mechanisms of the 5GC to devices or systems that are external to the 5GC. NEF 615 may maintain authorization and/or authentication information associated with such external devices or systems, such that NEF 615 is able to provide information, that is authorized to be provided, to the external devices or systems. Such information may be received from other network functions of the 5GC (e.g., as authorized by an administrator or other suitable entity associated with the 5GC), such as SMF 603, UPF 605, a charging function (“CHF”) of the 5GC, and/or other suitable network function. NEF 615 may communicate with external devices or systems (e.g., external devices 554) via DN 550 and/or other suitable communication pathways.

While environment 600 is described in the context of a 5GC, as noted above, environment 600 may, in some embodiments, include or implement one or more other types of core networks. For example, in some embodiments, environment 600 may be or may include a converged packet core, in which one or more elements may perform some or all of the functionality of one or more 5GC network functions and/or one or more EPC network functions. For example, in some embodiments, AMF 515 may include, may implement, may be implemented by, and/or may otherwise be associated with MME 516; SMF 603 may include, may implement, may be implemented by, and/or may otherwise be associated with SGW 517; PCF 607 may include, may implement, may be implemented by, and/or may otherwise be associated with a PCRF (e.g., PCF/PCRF 525); NEF 615 may include, may implement, may be implemented by, and/or may otherwise be associated with a SCEF (e.g., NEF/SCEF 549); and so on.

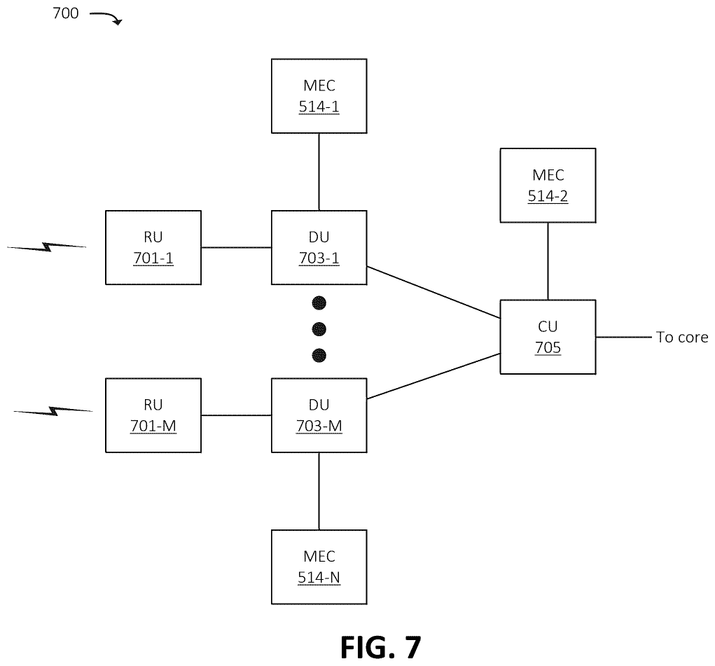

FIG. 7 illustrates an example RAN environment 700, which may be included in and/or implemented by one or more RANs (e.g., RAN 510 or some other RAN). In some embodiments, a particular RAN 510 may include one RAN environment 700. In some embodiments, a particular RAN 510 may include multiple RAN environments 700. In some embodiments, RAN environment 700 may correspond to a particular gNB 511 of RAN 510. In some embodiments, RAN environment 700 may correspond to multiple gNBs 511. In some embodiments, RAN environment 700 may correspond to one or more other types of base stations of one or more other types of RANs. As shown, RAN environment 700 may include Central Unit (“CU”) 705, one or more Distributed Units (“DUs”) 703-1 through 703-M (referred to individually as “DU 703,” or collectively as “DUs 703”), and one or more Radio Units (“RUs”) 701-1 through 701-M (referred to individually as “RU 701,” or collectively as “RUs 701”).

CU 705 may communicate with a core of a wireless network (e.g., may communicate with one or more of the devices or systems described above with respect to FIG. 6, such as AMF 515 and/or UPF 605) and/or some other device or system such as MEC 514. In the uplink direction (e.g., for traffic from UEs 115 to a core network), CU 705 may aggregate traffic from DUs 703, and forward the aggregated traffic to the core network. In some embodiments, CU 705 may receive traffic according to a given protocol (e.g., Radio Link Control (“RLC”) traffic) from DUs 703, and may perform higher-layer processing (e.g., may aggregate/process RLC packets and generate Packet Data Convergence Protocol (“PDCP”) packets based on the RLC packets) on the traffic received from DUs 703.

CU 705 may receive downlink traffic (e.g., traffic from the core network, traffic from a given MEC 514, etc.) for a particular UE 115, and may determine which DU(s) 703 should receive the downlink traffic. DU 703 may include one or more devices that transmit traffic between a core network (e.g., via CU 705) and UE 115 (e.g., via a respective RU 701). DU 703 may, for example, receive traffic from RU 701 at a first layer (e.g., physical (“PHY”) layer traffic, or lower PHY layer traffic), and may process/aggregate the traffic to a second layer (e.g., upper PHY and/or RLC). DU 703 may receive traffic from CU 705 at the second layer, may process the traffic to the first layer, and provide the processed traffic to a respective RU 701 for transmission to UE 115.

RU 701 may include hardware circuitry (e.g., one or more RF transceivers, antennas, radios, and/or other suitable hardware) to communicate wirelessly (e.g., via an RF interface) with one or more UEs 115, one or more other DUs 703 (e.g., via RUs 701 associated with DUs 703), and/or any other suitable type of device. In the uplink direction, RU 701 may receive traffic from UE 115 and/or another DU 703 via the RF interface and may provide the traffic to DU 703. In the downlink direction, RU 701 may receive traffic from DU 703, and may provide the traffic to UE 115 and/or another DU 703.

One or more elements of RAN environment 700 may, in some embodiments, be communicatively coupled to one or more MECs 514. For example, DU 703-1 may be communicatively coupled to MEC 514-1, DU 703-M may be communicatively coupled to MEC 514-N, CU 705 may be communicatively coupled to MEC 514-2, and so on. MECs 514 may include hardware resources (e.g., configurable or provisionable hardware resources) that may be configured to provide services and/or otherwise process traffic to and/or from UE 115, via a respective RU 701.

For example, DU 703-1 may route some traffic, from UE 115, to MEC 514-1 instead of to a core network via CU 705. MEC 514-1 may process the traffic, perform one or more computations based on the received traffic, and may provide traffic to UE 115 via RU 701-1. As discussed above, MEC 514 may include, and/or may implement, some or all of the functionality described above with respect to UPF 605, AF 530, and/or one or more other devices, systems, VNFs, CNFs, etc. In this manner, ultra-low latency services may be provided to UE 115, as traffic does not need to traverse DU 703, CU 705, links between DU 703 and CU 705, and an intervening backhaul network between RAN environment 700 and the core network.

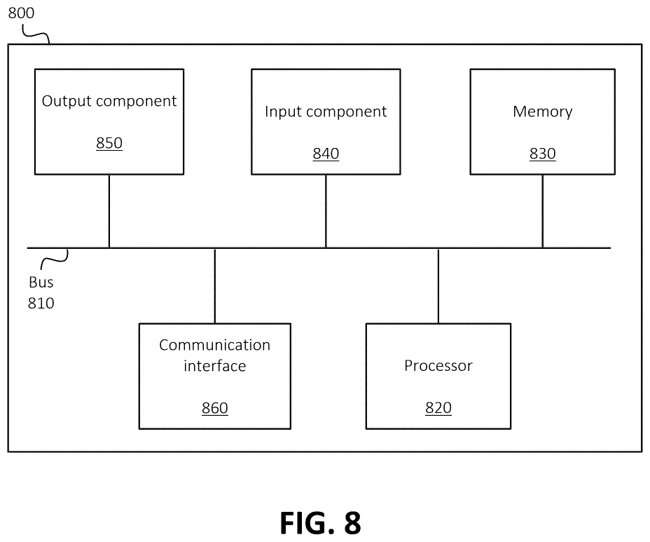

FIG. 8 illustrates example components of device 800. One or more of the devices described above may include one or more devices 800. Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, a set of provisioned hardware resources of a cloud computing system, or other suitable type of hardware that interprets and/or executes instructions (e.g., processor-executable instructions). In some embodiments, processor 820 may be or may include one or more hardware processors. Memory 830 may include any type of dynamic storage device that may store information and instructions for execution by processor 820, and/or any type of non-volatile storage device that may store information for use by processor 820.

Input component 840 may include a mechanism that permits an operator to input information to device 800 and/or other receives or detects input from a source external to input component 840, such as a touchpad, a touchscreen, a keyboard, a keypad, a button, a switch, a microphone or other audio input component, etc. In some embodiments, input component 840 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 850 may include a mechanism that outputs information to the operator, such as a display, a speaker, one or more light emitting diodes (“LEDs”), etc.

Communication interface 860 may include any transceiver-like mechanism that enables device 800 to communicate with other devices and/or systems (e.g., via RAN 510, RAN 512, DN 550, etc.). For example, communication interface 860 may include an Ethernet interface, an optical interface, a coaxial interface, or the like. Communication interface 860 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 800 may include more than one communication interface 860. For instance, device 800 may include an optical interface, a wireless interface, an Ethernet interface, and/or one or more other interfaces.

Device 800 may perform certain operations relating to one or more processes described above. Device 800 may perform these operations in response to processor 820 executing instructions, such as software instructions, processor-executable instructions, etc. stored in a computer-readable medium, such as memory 830. A computer-readable medium may be defined as a non-transitory memory device. A memory device may include space within a single physical memory device or spread across multiple physical memory devices. The instructions may be read into memory 830 from another computer-readable medium or from another device. The instructions stored in memory 830 may be processor-executable instructions that cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-4), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive a first set of artificial intelligence/machine learning (“AI/ML”) models;
receive first locally captured video information;
generate a second set of AI/ML models based on the first set of AI/ML models and the locally captured video information;
receive second locally captured video information;
identify, based on the second locally captured video information and the second set of AI/ML models, one or more classifications for the second locally captured video information; and
output, via a network and to an action system, the one or more classifications, without outputting the second locally captured video information via the network,
wherein the action system identifies a particular action associated with the one or more classifications, and
performs the identified particular action.

2. The device of claim 1, further comprising:
one or more AI/ML processing units that identify the one or more classifications for the second locally captured video information.

3. The device of claim 1, further comprising:
network circuitry to implement at least one of:
a Local Area Network (“LAN”), or
a wireless LAN (“WLAN”).

4. The device of claim 3, wherein the network circuitry is first network circuitry, wherein the device further comprises second network circuitry to communicate with the network.

5. The device of claim 4, wherein the second network circuitry includes wireless network circuitry that implements at least one of a Long-Term Evolution (“LTE”) radio access technology (“RAT”) or a Fifth Generation (“5G”) RAT.

6. The device of claim 3, wherein the locally captured video information is received from one or more cameras that are communicatively coupled to the device via the LAN or the WLAN.

7. The device of claim 1, wherein the second set of AI/ML models are maintained locally, without outputting the second set of AI/ML models via the network.

8. A non-transitory computer-readable medium, storing a plurality of processor-executable instructions to:
receive a first set of artificial intelligence/machine learning (“AI/ML”) models;
receive first locally captured video information;
generate a second set of AI/ML models based on the first set of AI/ML models and the locally captured video information;
receive second locally captured video information;
identify, based on the second locally captured video information and the second set of AI/ML models, one or more classifications for the second locally captured video information; and
output, via a network and to an action system, the one or more classifications, without outputting the second locally captured video information via the network,
wherein the action system identifies a particular action associated with the one or more classifications, and
performs the identified particular action.

9. The non-transitory computer-readable medium of claim 8, wherein identifying the one or more classifications for the second locally captured video information is performed by one or more AI/ML processing units.

10. The non-transitory computer-readable medium of claim 8, wherein a device that executes the processor-executable instructions comprises:
network circuitry to implement at least one of:
a Local Area Network (“LAN”), or
a wireless LAN (“WLAN”).

11. The non-transitory computer-readable medium of claim 10, wherein the network circuitry is first network circuitry, wherein the device further comprises second network circuitry to communicate with the network.

12. The non-transitory computer-readable medium of claim 11, wherein the second network circuitry includes wireless network circuitry that implements at least one of a Long-Term Evolution (“LTE”) radio access technology (“RAT”) or a Fifth Generation (“5G”) RAT.

13. The non-transitory computer-readable medium of claim 10, wherein the locally captured video information is received from one or more cameras that are communicatively coupled to the device via the LAN or the WLAN.

14. The non-transitory computer-readable medium of claim 8, wherein the second set of AI/ML models are maintained locally, without outputting the second set of AI/ML models via the network.

15. A method, comprising:
receiving a first set of artificial intelligence/machine learning (“AI/ML”) models;
receiving first locally captured video information;
generating a second set of AI/ML models based on the first set of AI/ML models and the locally captured video information;
receiving second locally captured video information;
identifying, based on the second locally captured video information and the second set of AI/ML models, one or more classifications for the second locally captured video information; and
outputting, via a network and to an action system, the one or more classifications, without outputting the second locally captured video information via the network,
wherein the action system identifies a particular action associated with the one or more classifications, and
performs the identified particular action.

16. The method of claim 15, wherein identifying the one or more classifications for the second locally captured video information is performed by one or more AI/ML processing units.

17. The method of claim 15, wherein a device that receives the first and second locally captured video information comprises network circuitry to implement at least one of:
a Local Area Network (“LAN”), or
a wireless LAN (“WLAN”).

18. The method of claim 17, wherein the network circuitry is first network circuitry, wherein the device further comprises second network circuitry to communicate with the network.

19. The method of claim 18, wherein the second network circuitry includes wireless network circuitry that implements at least one of a Long-Term Evolution (“LTE”) radio access technology (“RAT”) or a Fifth Generation (“5G”) RAT.

20. The method of claim 17, wherein the locally captured video information is received from one or more cameras that are communicatively coupled to the device via the LAN or the WLAN.
